(19) United States
(12) Patent Application Publication
(10) Pub. No.: US 2012/0124272 A1
(43) Pub. Date: May 17, 2012

(54) FLASH MEMORY APPARATUS

(75) Inventors: Ching-Hua Hsiao, Hsinchu City (TW); Jean-Yi Lee, Taoyuan County (TW); Tsung-Hsien Lee, Hsinchu County (TW); Sheng-An Yang, Kaohsiung County (TW)

(73) Assignee: eMEMORY TECHNOLOGY INC., Hsinchu (TW)

(21) Appl. No.: 12/944,737

(22) Filed: Nov. 12, 2010

(51) Int. Cl. G06F 12/02

(52) U.S. Cl. 711/103; 711/E12.008

(57) ABSTRACT

A flash memory apparatus including a command analysis unit, a first flash memory and a second flash memory is provided. The command analysis unit with a plurality of command buffers receives a plurality of command elements and queues the command elements in the command buffers in sequence. The command analysis unit transmits the command elements simultaneously to the first flash memory and the second flash memory through a command bus, and the flash memory device writes/reads the first flash memory and the second flash memory simultaneously through a first data bus and a second data bus different from the first data bus respectively to execute an operation. The flash memory device queues the command elements so as to enhance the command throughput, and the flash memories share the same command bus for dual channel operation.

### BACKGROUND

1. Field of the Invention

The invention relates to a flash memory technique. More particularly, the invention relates to a flash memory apparatus having command queuing and dual channel functions.

2. Description of Related Art

Growth of market demand for digital cameras, smart cameras and MP3 players is rapid, so that consumer's demand for storage media is rapidly increased. A flash memory is a programmable memory, and has advantages of non-volatile data, power saving, small size and none mechanical structure, etc., which is suitable to serve as a storage media of a portable electronic device. Therefore, in recent years, the flash memory industry becomes popular in electronics industry.

In a conventional flash memory technique, flash memories provided by different providers can be controlled through suitable memory protocols. The memory protocol is a command sent to a designated memory address for executing an operation according to operations customized by the memory providers, and the operations are, for example, a data write, read or erase operation.

Referring to FIG. 1, FIG. 1 is a schematic diagram illustrating commands executed by a conventional flash memory apparatus. As shown in FIG. 1, commands CM1 and CM2 correspond to a command format of the write operation of the flash memory apparatus, and the commands CM1 and CM2 respectively consist of a plurality of command elements CE, for example, a designated memory command element FI_CE, an instruction command element FI_CMD, an address command element FI_ADDR, a data command element FI_DATA, a ready command element FI_READY and a status command element FI_{—} STATUS, etc. According to the conventional flash memory technique, when a previous command CM1 is transmitted to the flash memory apparatus, a next command CM2 can be received and executed only after the flash memory apparatus complete executing the command CM1, i.e. there is a prepare time between transmissions of the commands CM1 and CM2, so that the flash memory apparatus can complete executing the command CM1 before the prepare time. Therefore, during a process of controlling the flash memory apparatus, the commands cannot be continuously inputted to the flash memory apparatus. Moreover, since an accessing rate of the flash memory is limited by a bus transmission rate and a control method of data transmission, how to increase the accessing rate, or reduce a processing time of the read or write command is a research direction of the current flash memory technology.

### SUMMARY

The invention is directed to a flash memory apparatus, which can increase a command throughput, and flash memories therein uses a same command bus and respective data buses to perform a dual channel operation, so as to increase an accessing rate.

The invention provides a flash memory apparatus including a command analysis unit, at least a first flash memory and at least a second flash memory. The command analysis unit with a plurality of command buffers receives a plurality of command elements and queues the command elements in the command buffers in sequence. The first flash memory is coupled to the command analysis unit through a command bus and a first data bus. The second flash memory is also coupled to the command analysis unit through the command bus and a second data bus different to the first data bus. The command analysis unit transmits the command elements simultaneously to the first flash memory and the second flash memory through the command bus, and the flash memory apparatus writes/reads the first flash memory and the second flash memory simultaneously through the first data bus and the second data bus to execute an operation.

In an embodiment of the invention, the command analysis unit further includes a command controller, which outputs a plurality of memory control signals according to the command elements.

In an embodiment of the invention, the flash memory apparatus further includes a flash memory interface coupled to the command analysis unit, the command analysis unit transmits the memory control signals simultaneously to the first flash memory and the second flash memory through the command bus by using the flash memory interface.

In an embodiment of the invention, the flash memory apparatus further includes a transmission control unit, which is coupled to the command analysis unit. The transmission control unit transmits/receives a first part data and a second part data simultaneously to/from the first flash memory and the second flash memory through the first data bus and the second data bus.

According to the above descriptions, the flash memory apparatus of the invention queues the command elements to improve a command throughput, and the flash memories therein share the same command bus, and the flash memories belonged to different channels have different data buses, and the flash memories of the same channel share the same data bus, so as to achieve multi-channel operation and increase a data accessing rate.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating commands executed by a conventional flash memory apparatus.

FIG. 2 is a functional block diagram illustrating a flash memory apparatus according to a first embodiment of the invention.

FIG. 3 is a schematic diagram illustrating commands executed by a flash memory apparatus according to a first embodiment of the invention.

FIG. 4 is a schematic diagram illustrating a dual channel operation of a flash memory apparatus according to a first embodiment of the invention.

FIG. 5 is a functional block diagram illustrating a flash memory apparatus according to a second embodiment of the invention.

### DETAILED DESCRIPTION OF DISCLOSED EMBODIMENTS

Reference will now be made in detail to the present preferred embodiments of the invention, examples of which are illustrated in the accompanying drawings. Wherever possible, the, same reference numbers are used in the drawings and the description to refer to the same or like parts.

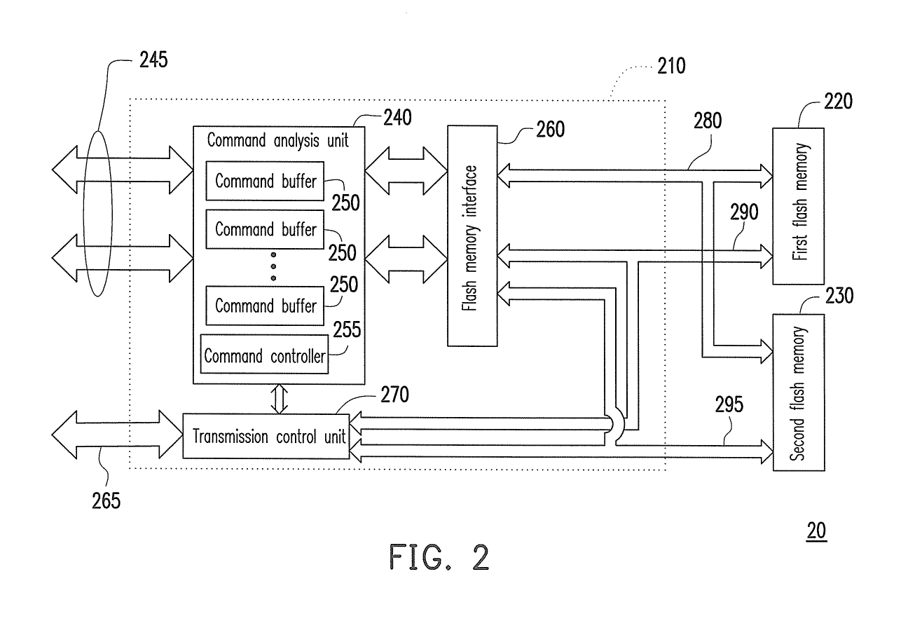

Referring to FIG. 2, FIG. 2 is a functional block diagram illustrating a flash memory apparatus 20 according to a first embodiment of the invention. As shown in FIG. 2, the flash memory apparatus 20 includes a control module 210, a first flash memory 220 and a second flash memory 230. The control module 210 obtains command and data provided by external (for example, a host (not shown) or other devices capable of communicating with the flash memory apparatus 20) through a command accessing bus 245 and a data accessing bus 265, so as to execute a corresponding operation. The control module 210 includes a command analysis unit 240, and the command analysis unit 240 includes a plurality of command buffers 250. Wherein, the command analysis unit 240 receives a plurality of command elements CE in a command through the command accessing bus 245, and queues the command elements CE in the command buffers 250 in sequence.

The first flash memory 220 and the second flash memory 230 share a same command bus 280, and are coupled to the command analysis unit 240 through a flash memory interface 260. The first flash memory 220 and the second flash memory 230 are coupled to the command analysis unit 240 through a first data bus 290 and a second data bus 295 respectively. Moreover, the command analysis unit 240 transmits memory control signals simultaneously to the first flash memory 220 and the second flash memory 230 through the command bus 280 according to the command elements CE, and the flash memory apparatus 20 writes/reads the first flash memory 220 and the second flash memory 230 simultaneously through the first data bus 290 and the second data bus 295 to execute a read, erase or write operation. In other words, the flash memory apparatus 20 may perform a dual channel operation to the first flash memory 220 and the second flash memory 230 by using the command bus 280, the first data bus 290 and the second data bus 295, so as to increase a data accessing rate. Moreover, in the present embodiment, the operation of the flash memory apparatus 20 can be a read operation, a write operation, a ready operation or a memory status operation, and these operations and corresponding command formats thereof can be varied along with memory protocols of different memory providers, which are not limited by the invention.

Referring to FIG. 2, the command analysis unit 240 further includes a command controller 255. In the present embodiment, the command controller 255 can be implemented by a micro controller unit (MCU) (though the invention is not limited thereto), which can output the corresponding memory control signals according to the command elements CE. Moreover, the control module 210 further includes the flash memory interface 260. The flash memory interface 260 is coupled to the command analysis unit 240, and the command analysis unit 240 can communicate with the first flash memory 220 and the second flash memory 230 through the flash memory interface 260, so as to transmit the memory control signals simultaneously to the first flash memory 220 and the second flash memory 230 through the command bus 280.

In the present embodiment, the control module 210 further includes a transmission control unit 270. The transmission control unit 270 is coupled to the command analysis unit 240, and the transmission control unit 270 can obtain write data through the data accessing bus 265, or read data from the first flash memory 220 and/or the second flash memory 230. The transmission control unit 270 divides a predetermined data to be written into the flash memory apparatus 20 into a first part data and a second part data, and writes the first part data and the second part data simultaneously to the first flash memory 220 and the second flash memory 230 through the first data bus 290 and the second data bus 295. On the other hand, the transmission control unit 270 can also read the first part data and the second part data simultaneously from the first flash memory 220 and the second flash memory 230 through the first data bus 290 and the second data bus 295, and combine the first part data and the second part data into the predetermined data to be read from the flash memory apparatus 20.

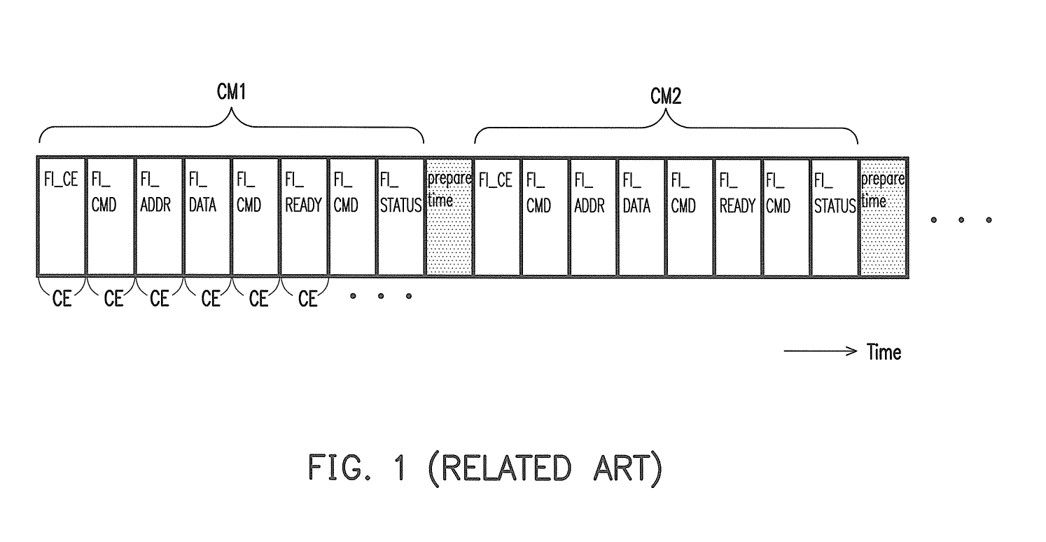

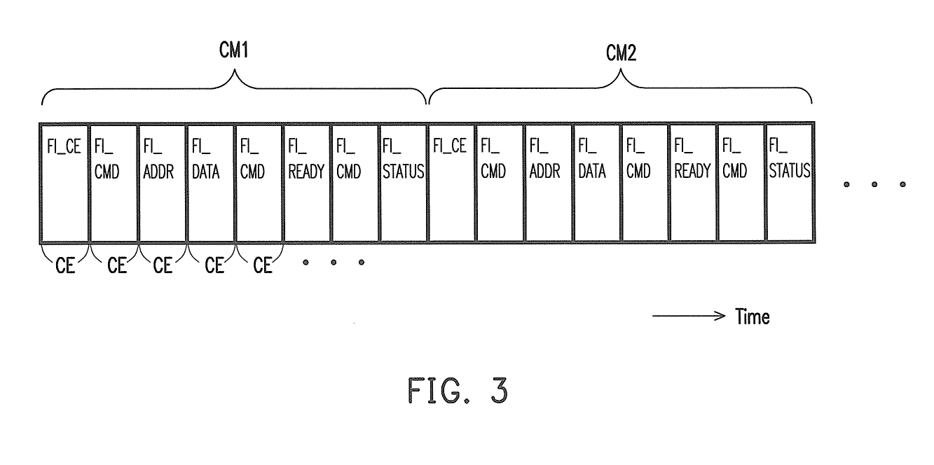

To fully convey the concept of the invention to those skilled in the art, a command execution process of the command analysis unit 240 is described below. Referring to FIG. 3, FIG. 3 is a schematic diagram illustrating commands executed by the flash memory apparatus 20 according to the first embodiment of the invention. Referring to FIG. 3, similar to FIG. 1, commands CM1 and CM2 respectively consist of a plurality of command elements CE, and are transmitted to the command analysis unit 240 through the command accessing bus 245. The command elements CE may include a designated memory command element FI_CE, an instruction command element FI_CMD, an address command element FI_ADDR, a data command element FI_DATA, a ready command element FI_READY and a status command element FI_STATUS, etc of different command element types. The command elements CE may contain different information according to different types thereof, for example, the address command element FI_ADDR contains a memory address to be accessed, and the designated memory command element FI_CE contains information of whether or not to enable the first flash memory 220 and/or the second flash memory 230. Moreover, different operations correspond to different formation of the command elements CE, and in the present embodiment, the commands CM1 and CM2 all have a command element formation corresponding to the write operation.

It is to be noted that the capacity of the address command element FI_ADDR is determined according to the capacity of the first flash memory 220 or the second flash memory 230 and the operation executed of the flash memory apparatus 20. For example, when the flash memory apparatus 20 performs an erase operation, the capacity of the address command element FI_ADDR is designed as 3 bytes. And when the flash memory apparatus 20 performs a write operation, the capacity of the address commend element FI_ADDR is designed as 5 bytes.

Comparing FIG. 3 and FIG. 1 and referring to FIG. 2, since the command analysis unit 240 includes a plurality of the command buffers 250, the command analysis unit 240 queues the received command elements CE in the command buffers 250 in sequence, so that the flash memory apparatus 20 can continuously receive the commands CM1, CM2, . . . without waiting a period of prepare time for receiving the command CM2 after reception of the command CM1 is completed. In other words, the flash memory apparatus 20 uses the command buffers 250 in the command analysis unit 240 to achieve command queuing, so as to shorten a time for transmitting each of the commands (a prepare time is saved between two commands), and accordingly increase a command transmission rate.

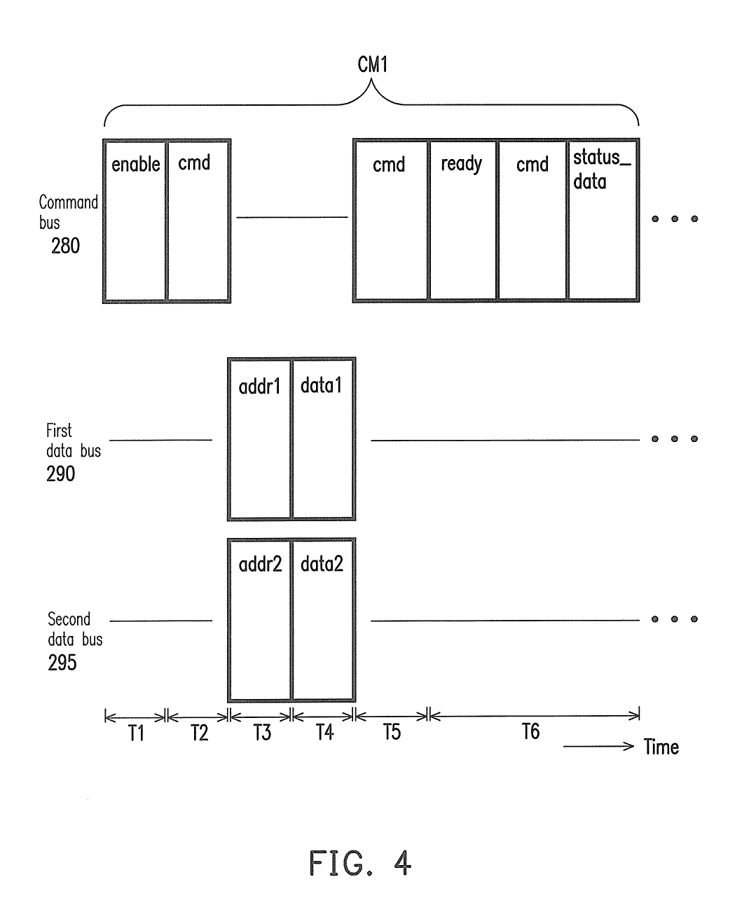

A command execution process for the dual channel operation performed by the flash memory apparatus 20 is described below. Referring to FIG. 4 and FIG. 2, FIG. 4 is a schematic diagram illustrating a dual channel operation of the flash memory apparatus 20 according to the first embodiment of the invention. As shown in FIG. 4, it is assumed that when the flash memory apparatus 20 is set to perform a dual channel write operation (i.e. the command analysis unit 240 executes the command CM1), the command analysis unit 240 transmits the command CM1 simultaneously to the first flash memory 220 and the second flash memory 230 through the flash memory interface 260. Moreover, the command controller 255 can generate the memory control signals according to the command elements CE. The so-called “memory control signals” refer to an enable signal enable, a command signal cmd, a ready signal ready, and a status data signal status_data that are simultaneously transmitted to the first flash memory 220 and the second flash memory 230 through the command bus 280, or other signals transmitted through the command bus 280 for controlling operations of the memories.

Referring to FIG. 2 and FIG. 4 again, during a time period T1, the command CM1 first designates whether the memories are all in an enable mode, so as to determine whether or not to perform the dual channel operation. In detail, during the time period T1, the command controller 255 generates the enable signal enable according to the designated memory command element FI_CE of the command CM1 shown in FIG. 3. The command analysis unit 240 transmits the enable signal enable to the first flash memory 220 and the second flash memory 230 through the flash memory interface 260 and the command bus 280, so as to designate whether the first flash memory 220 and the second flash memory 230 are in the enable mode. In other words, the flash memory apparatus 20 can access one of the first flash memory 220 and the second flash memory 230, and can also perform the dual channel operation simultaneously to the first flash memory 220 and the second flash memory 230.

Next, during a time period T2, the command analysis unit 240 sends a command to the memories to perform the write operation. In detail, the command controller 255 generates the command signal cmd according to the instruction command element FI_CMD shown in FIG. 3. Meanwhile, the first flash memory 220 and the second flash memory 230 receive the command signal cmd through the command bus 280. During a time period T3, the first flash memory 220 and the second flash memory 230 respectively receive an address addr1 and an address addr2 through the first data bus 290 and the second data bus 295, so as to simultaneously perform addressing operations of the first flash memory 220 and the second flash memory 230. Moreover, during a time period T4, the first flash memory 220 and the second flash memory 230 respectively receive a first part data data1 and a second part data data2 through the first and the second data buses 290 and 295, so as to write these data into the first flash memory 220 and the second flash memory 230. Then, during a time period T5, the command controller 255 generates the command signal cmd. The first flash memory 220 and the second flash memory 230 receive the command signal cmd through the command bus 280, so that the command signal cmd have been received by the first flash memory 220 and the second flash memory 230. Deduced by analogy, during a time period T6, the command analysis unit 240 continuously transmits the ready signal ready, the command signal cmd, and the status data signal status_data to the first flash memory 220 and the second flash memory 230 through the flash memory interface 260 and the command bus 280 for communication, so as to complete the dual channel write operation.

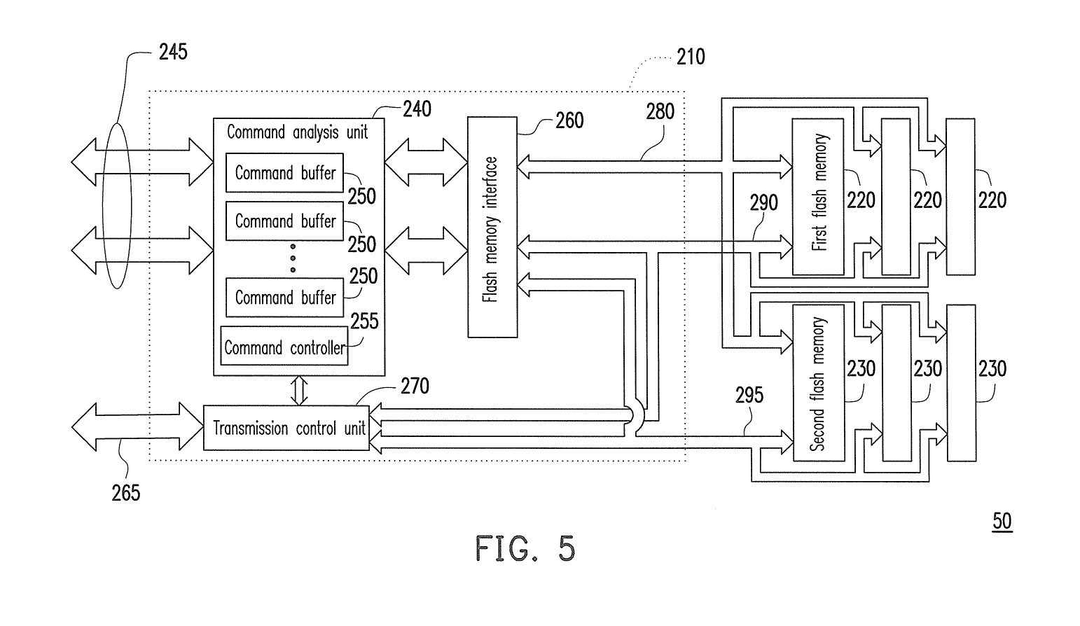

Moreover, in the embodiments complied with the invention, the first flash memory 220 and the second flash memory 230 can be independent flash memory regions, and can also be a set of a plurality of flash memories. Accordingly, another embodiment is provided to those skilled in the art for a further understanding of the invention, in which utilization numbers of the first flash memories 220 and the second flash memories 230 are not limited by the present embodiment. Referring to FIG. 5, FIG. 5 is a functional block diagram illustrating a flash memory apparatus according to a second embodiment of the invention. The present embodiment is similar to the first embodiment, and therefore descriptions of the same parts are not repeated, and a difference there between is that the flash memory apparatus 50 includes a plurality of first flash memories 220 and a plurality of second flash memories 230, and each of the first flash memories 220 and each of the second flash memories 230 share the same command bus 280. Each of the first flash memories 220 transmits addresses or data through the first data bus 290, and each of the second flash memories 230 transmits addresses or data through the second data bus 295. The other detailed operations are as that described in the aforementioned embodiment, and therefore detailed descriptions thereof are not repeated.

In summary, the flash memory apparatus of the invention queues the command elements to improve a command throughput, and the flash memories therein share the same command bus, and each of the flash memories is coupled to a different data bus, so as to achieve multi-channel operation and increase a data accessing rate.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A flash memory apparatus, comprising:
a command analysis unit, having a plurality of command buffers, receives a plurality of command elements and queuing the command elements in the command buffers in sequence;
at least a first flash memory, coupled to the command analysis unit through a command bus and a first data bus; and
at least a second flash memory, coupled to the command analysis unit through the command bus and a second data bus, wherein the command analysis unit transmits the command elements to the first flash memory and the second flash memory simultaneously through the command bus, and the flash memory apparatus writes or reads the first flash memory and the second flash memory simultaneously through the first data bus and the second data bus to execute an operation.

2. The flash memory apparatus as claimed in claim 1, wherein the command analysis unit further comprises:
a command controller, for outputting a plurality of memory control signals according to the command elements.

3. The flash memory apparatus as claimed in claim 2, wherein the flash memory apparatus further comprises:
a flash memory interface, coupled to the command analysis unit, wherein the command analysis unit transmits the memory control signals to the first flash memory and the second flash memory simultaneously through the command bus by using the flash memory interface.

4. The flash memory apparatus as claimed in claim 1, wherein the flash memory apparatus further comprises:
a transmission control unit, coupled to the command analysis unit, for transmitting/receiving a first part data and a second part data to or from the first flash memory and the second flash memory simultaneously through the first data bus and the second data bus.

5. The flash memory apparatus as claimed in claim 4, wherein the transmission control unit divides a predetermined data into the first part data and the second part data, and writes the first part data and the second part data simultaneously to the first flash memory and the second flash memory respectively through the first data bus and the second data bus.

6. The flash memory apparatus as claimed in claim 4, wherein the transmission control unit reads the first part data and the second part data simultaneously from the first flash memory and the second flash memory respectively through the first data bus and the second data bus, wherein the first part data and the second part data are combined to form the predetermined data.

7. The flash memory apparatus as claimed in claim 1, wherein the command elements comprise a designated memory command element, an instruction command element, an address command element, a data command element, a ready command element or a status command element.

8. The flash memory apparatus as claimed in claim 7, wherein a capacity of the address command element is determined according to a capacity of the first flash memory or a capacity of the second flash memory and the said operation.

9. The flash memory apparatus as claimed in claim 1, wherein the operation comprises a read operation, a write operation, a ready operation , a erase operation or a memory status operation.
